(19) United States
(12) Patent Application Publication
(10) Pub. No.: US 2017/0071252 A1
(43) Pub. Date: Mar. 16, 2017

(54) ELECTRONIC CIGARETTE AND METHOD FOR MANUFACTURING SAME

(71) Applicant: KIMREE HI-TECH INC., Tortola (VG)

(72) Inventor: Qiuming Liu, Shenzhen, Guangdong (CN)

(21) Appl. No.: 15/125,973

(22) PCT Filed: Mar. 14, 2014
(86) PCT No.: PCT/CN2014/073468

§ 371 Date: Sep. 14, 2016

(51) Int. Cl. A24F 47/00; H01R 13/627; F16B 2/20

(52) U.S. Cl. CPC A24F 47/008; F16B 2/20; H01R 13/6271

(57) ABSTRACT

The invention is related to an electronic cigarette, comprising an atomizing assembly and a battery assembly, wherein a connection structure is provided at the position where the atomizing assembly and the battery assembly are butt-jointed, and the connection structure comprises a first connector and a second connector butt-jointed with each other. The first connector is provided with a butt-joint groove into which the second connector is inserted. The second connector is provided with a connecting arm and a guide part which is formed by extending from one end of the connecting arm close to the first connector and has a reduced diameter, the guide part guiding the second connector to be inserted into the butt-joint groove. The electronic cigarette has the advantages of firm connection, convenient mounting and small wear. Also provided is a method for manufacturing the electronic cigarette.

### TECHNICAL FIELD

The present invention relates to electric heating products, and more particularly relates to an electronic cigarette and a method for manufacturing same.

### BACKGROUND

An electronic cigarette generally comprises an atomizing assembly and a battery assembly. In the electronic cigarette of prior art, connection methods between the atomizing assembly and the battery assembly is a threaded connection and a direct inserted connection. The threaded connection has the disadvantages of an easy mismatch, a poor reliability and an inconvenient disassembly. Besides, for the direct inserted connection, it is difficult to align during an insertion, and there is an abrasion for an inserted electrode, leading to an inconvenient use and bad users' experience.

### SUMMARY

The technical problems that the present invention will solve are the connection mismatch and inconvenient disassembly of the atomizing assembly and battery assembly of the electronic cigarette in prior art, it is difficult to align during insertion, and there is abrasion for the inserted electrode. The present invention provides an electronic cigarette which has the advantages of a reliable connection, convenient assembly and small abrasion and a method for manufacturing same.

The present invention provides an electronic cigarette, comprises an atomizing assembly and a battery assembly, a connection structure is provided at the position where the atomizing assembly and the battery assembly are butt-jointed, the connection structure comprises a first connector and a second connector that are butt-jointed with each other, the first connector is provided with a butt-joint groove into which the second connector is inserted; the second connector is provided with a connecting arm and a guide part which is formed by extending from one end of the connecting arm by way of reducing diameter, the end is close to the first connector, the guide part guides the second connector to insert into the butt-joint groove;

The connecting arm comprises outward protruded snap-fit parts, an inner wall of the butt-joint groove is provided with a guide channel providing an insertion guide for the snap-fit parts, and an accommodating groove which is communicated with the guide channel and is used for being in rotary snap-fit with the snap-fit parts.

Advantageously, the first connector is further provided with a locking part used for preventing the first connector from rotating with respect to the second connector.

Advantageously, the locking part is elastic bulges arranged at a side wall of the accommodating groove.

Advantageously, there is a guide face on the guide part, the guide face is arranged at an end away from the connecting arm.

Advantageously, the guide part is an inverted beveling angle or inverted rounding angle which is arranged at an end of the second connector close to the first connector, the inverted beveling angle or the inverted rounding angle encircles a circumferential face, the circumferential face forms the guide face.

Advantageously, the guide part is a step part which is formed by extending from an end of the second connector by way of gradually reducing a diameter, the end is close to the first connector, and a circumferential surface of the step part forms the guide face.

Advantageously, a first electrode is arranged outside the first connector, a second electrode is arranged outside the second connector and is electrically connected to the first electrode, the snap-fit parts is arranged at an outer side of the second electrode, the butt-joint groove is formed at an inner side of the first electrode.

Advantageously, an outer side of the first electrode is circumferentially provided with a catching piece, a part of the catching piece protrudes to form the elastic bulges, the first electrode is provided with an opening which matches sizes of the elastic bulges, the elastic bulges are exposed inside the butt-joint groove via the opening.

Advantageously, an outer side of the first electrode is provided with a groove which matches the shape of the catching piece, the catching piece is caught inside the groove.

Advantageously, the catching piece is a u-shaped elastic piece, the elastic bulges are arranged at two ends of the u-shaped elastic piece.

Advantageously, the catching piece is a catch spring with the opening, the elastic bulges are two radial inward protruded convex ribs.

Advantageously, the snap-fit parts is a metal piece, the locking part is a magnetic piece which is arranged at an inner wall of the accommodating groove and is used for attracting the snap-fit parts.

Advantageously, the quantities of the snap-fit parts and the elastic bulges are both two, the snap-fit parts are uniformly arranged at the outer side of the second electrode with equivalent interval.

Advantageously, a vertical distance of the elastic bulges protruding from the butt-joint groove is 1 mm-2 mm.

Advantageously, the first connector is mounted on the battery assembly, the second connector is arranged on the atomizing assembly.

The present invention further provides an electronic cigarette, comprises an atomizing assembly and a battery assembly, a connection structure is provided at the position where the atomizing assembly and the battery assembly are butt-jointed, the connection structure comprises a first connector and a second connector that are butt-jointed with each other, the first connector is provided with a butt-joint groove into which the second connector is inserted; the second connector is provided with a connecting arm and a guide part which is formed by extending from one end of the connecting arm by way of reducing diameter, the end is close to the first connector, the guide part guides the second connector to insert into the butt-joint groove;

The connecting arm comprises an outward protruded snap-fit parts, an inner wall of the butt-joint groove is provided with a guide channel providing an insertion guide for the snap-fit parts, and an accommodating groove which is communicated with the guide channel and is used for being in rotary snap-fit with the snap-fit parts;

There is a guide face on the guide part, the guide face is arranged at an end away from the connecting arm; the guide part is a step part which is formed by extending from one end of the second connector by way of gradually reducing a diameter, the end is close to the first connector; the connecting arm comprises an outward protruded locking part used for preventing the first connector from rotating with respect to the second connector; the locking part is two elastic bulges which are arranged at a side wall of the accommodating groove.

The present invention further provides an electronic cigarette manufacturing method, used for manufacturing the above-mentioned electronic cigarette, the electronic cigarette manufacturing method comprises following steps:

S1. providing a first connector and a second connector that are butt-jointed with each other; a first electrode is arranged outside the first connector, a second electrode is arranged outside the second connector, the first connector is provided with a butt-joint groove into which the second connector is inserted; an outer side of the second electrode is provided with an outward protruded snap-fit parts;

S2. forming a step part which is used for guiding the second connector to insert into the butt-joint groove by extending from one end of the second electrode by way of reducing diameter, the end being close to the first connector;

S3. arranging a guide channel which is connected to an outer end face of the first connector at a side wall of the butt-joint groove, and arranging an accommodating groove which is communicated with the guide channel at an end of the guide channel away from an outer end face of the first connector;

S4. providing a u-shaped elastic piece with two inward protruded elastic bulges on two ends, arranging a groove which matches with the u-shaped elastic piece at an outer side of the first electrode, and arranging an opening used for being inserted by the elastic bulges and protruding the elastic bulges from an interior of the butt-joint groove;

S5. providing a battery assembly and an atomizing assembly, catching the u-shaped elastic piece on an outer side of the first electrode, and inserting the elastic bulges into the opening, mounting the first connector with the u-shaped elastic piece on the battery assembly, mounting the second connector on the atomizing assembly, and inserting the second connector into the butt-joint groove, rotating and snap-fitting to form the electronic cigarette.

Implementing the Electronic Cigarette

and the method for manufacturing same of the present invention has following beneficial effects: by inserting the second connector into the first connector and rotating to snap-fit to realize the connection between the atomizing assembly and the battery assembly, the connection is reliable and it is convenient to disassemble; meanwhile, by arranging the guide part which is used for providing guide for inserting the second connector into the first connector on the second connector, it is convenient to precisely insert the second connector into the first connector, and there is no abrasion for the second connector and the first connector.

### BRIEF DESCRIPTION OF THE DRAWINGS

The invention will be further described with reference to the accompanying drawings and embodiments in the following.

FIG. 1 is an exploded structural schematic diagram of the electronic cigarette of the present invention;

FIG. 2 is an enlarged view of the part 1A in FIG. 1;

FIG. 3 is an overall structural schematic diagram of the second connector in FIG. 1;

FIG. 4 is a structural schematic diagram of the second embodiment of the second connector;

FIG. 5 is an exploded structural schematic diagram of the first connector in FIG. 1;

FIG. 6 is an exploded structural schematic diagram of the second embodiment of the first connector;

FIG. 7 is a structural schematic diagram of the battery assembly of the present invention;

FIG. 8 is an enlarged view of the part B in FIG. 7.

### DETAILED DESCRIPTION OF THE PREFERRED EMBODIMENT

Aiming at the drawbacks of an insecure connection of the atomizing assembly 1 and the battery assembly 2, difficult alignment during inserting and the abrasion, by arranging the guide part 321 on the second connector 32, the guide channel 312 is provided for inserting the second connector 32 into the first connector 31, and the second connector 32 is rotated with respect to the first connector 31 to snap-fit to realize the connection between the first connector 31 and the second connector 32. The connection is secure. The structure is simple. And it is convenient to assemble.

In order to better understand the technical features, purpose and effects of the present invention, the preferred embodiments will be described in detail in the following.

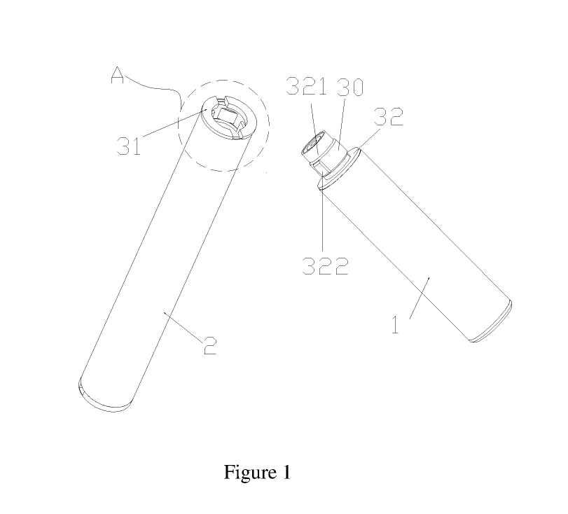

As shown in FIG. 1, the present invention provides an electronic cigarette, the electronic cigarette comprises an atomizing assembly 1 and a battery assembly 2, a connection structure is provided at the position where the atomizing assembly 1 and the battery assembly 2 are butt-jointed, the connection structure comprises a first connector 31 and a second connector 32 butt-jointed with each other; the first connector 31 is provided with a butt-joint groove 311 into which the second connector 32 is inserted; the second connector 32 is provided with a connecting arm 30 and a guide part 321 which is formed by extending from one end of the connecting arm 30 close to the first connector 31 by reducing diameter, the guide part 321 guides the second connector 32 to insert into the butt-joint groove 311. The connecting arm 30 is arranged at an outer side of the second connector 32, the guide part 321 is provided with a guide face, the guide face is arranged at an end away from the connecting arm 30. By arranging the guide part 321 and the guide face, it is convenient to align the second connector 32 to the butt-joint groove 311. The alignment is precise and it is difficult to abrade. Meanwhile, by catching the connecting arm 30 in the butt-joint groove 311, the connection is secure and it is difficult to break off.

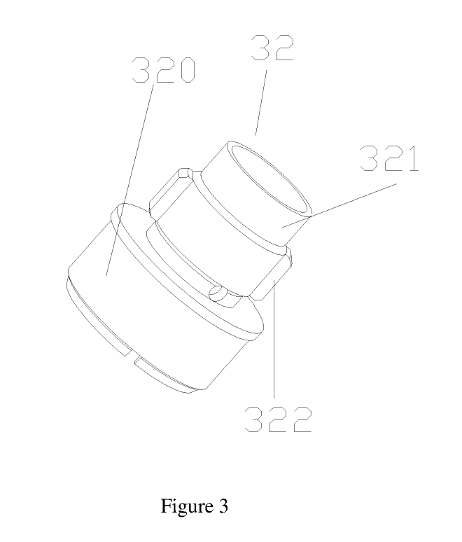

Specifically, as the second connector 32 of the first embodiment shown in FIG. 3, the guide part 321 is a step part which is formed by gradually reducing the diameter of an end of the second connector 32 close to the first connector 31, a circumferential surface of the step part encircles the guide face. It can be understood that when the extent of reducing the diameter is too large, the part of diameter reducing will shake a lot when inserted in the butt-joint groove 311, so the part without diameter reducing cannot be aligned to the butt-joint groove 311; when the extent of reducing the diameter is too small, the size of the guide part 321 is close to the size of the hole of the butt-joint groove 311, it cannot be aligned to the butt-joint groove 311, even if it aligns, the guide part 321 will be abraded during aligning. Therefore, a range of the size of diameter reducing is from 1 mm to 2 mm. Advantageously, the size of diameter reducing is 1.5 mm.

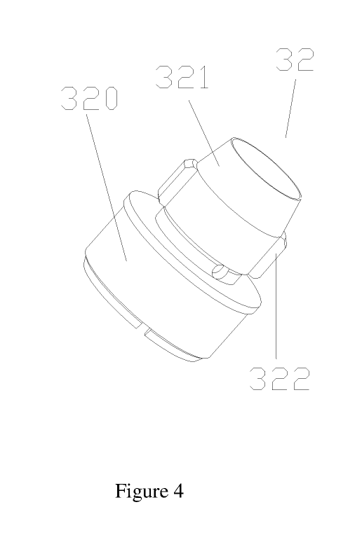

As the second connector 32 of the second embodiment shown in FIG. 4, the guide part 321 is an inverted beveling angle or inverted rounding angle (the inverted beveling angle is the second embodiment, FIG. 4 only shows the second embodiment; the inverted rounding angle is the third embodiment, this embodiment is not shown in the Figure) which is arranged at an end of the second connector 32 close to the first connector 31. The circumferential face of the inverted beveling angle or the inverted rounding angle encircles the guide face. When it is the chamfer, the incline range of the chamfer is 10°-50°. In the present invention, the advantageous angle is 30°.

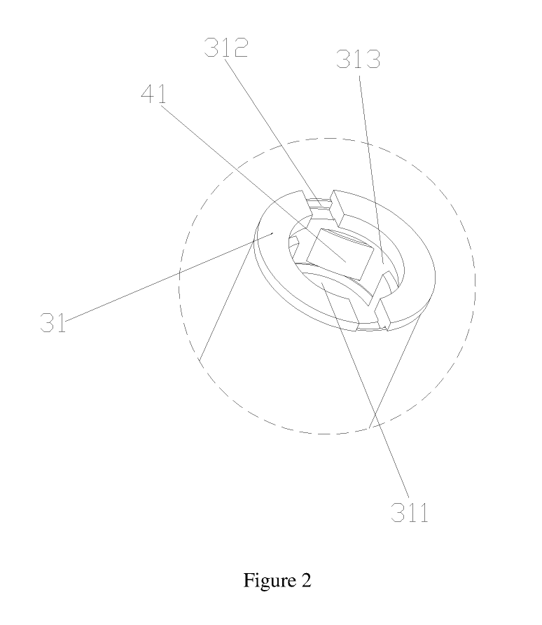

As shown in FIG. 2, in order to secure the connection between the first connector 31 and the second connector 32, the connecting arm 30 further comprises outward protruded snap-fit parts 322. An inner wall of the butt-joint groove 311 is provided with a guide channel 312 providing an insertion guide for the snap-fit parts 322, and an accommodating groove 313 which is connected to the guide channel 312 and is used for being in rotary snap-fit with the snap-fit parts 322. The accommodating groove 313 is an arc concave part which is formed by denting an inner side wall of the butt-joint groove 311 outward.

The guide channel 312 is extended axially inward from an outer end face of the butt-joint groove 311. The accommodating groove 313 is arranged on an outer end face of the guide channel 312 away from the butt-joint groove 311.

The specific inserting process is as follow. The snap-fit parts 322 is inserted into the accommodating groove 313 via the guide channel 312, then the snap-fit parts 322 is rotated to be accommodated in the accommodating groove 313 and is staggered with the guide channel 312. Then the first connector 31 is connected to the second connector 32.

In order to insert conveniently and locate, the snap-fit parts 322 is a stripe structure. The guide channel 312 is a stripe concave part which is arranged in the butt-joint groove 311 and matches the shape of the snap-fit parts 322.

As shown in FIGS. 2, 3 and 6, specifically, a first electrode 310 is arranged outside the first connector 31, a second electrode 320 is arranged outside the second connector 32 and is electrically connected to the first electrode 310, the snap-fit part 322 is arranged at an outer side of the second electrode 320, the butt-joint groove 311 is formed at an inner side of the first electrode 310. The first electrode 310 and the second electrode 320 are electrically connected by inserting.

The first connector 31 is further provided with a locking part used for preventing the first connector 31 from rotating with respect to the second connector 32. By preventing the snap-fit part 322 from rotating in the accommodating groove 313 to realize the locking part to prevent the first connector 31 from rotating with respect to the second connector 32, and the second connector 32 falling off the first connector 31 can be avoided.

Specifically, the structure of the locking part is as follow. As shown in FIG. 1, the locking part is at least two elastic bulges 41 arranged at a side wall of the accommodating groove 313, the snap-fit parts 322 are restricted on sides of the elastic bulges 41 of the accommodating groove 313. The snap-fit parts 322 enters the accommodating groove 313 via the guide channel 312, the second connector 32 is rotated to circumferentially rotate the snap-fit parts 322 in the accommodating groove 313. At this time, one of the snap-fit parts 322 squeezes the elastic bulges 41 until the snap-fit parts 322 crosses the elastic bulges 41. Finally, the snap-fit parts 322 are restricted on sides of the elastic bulges 41 of the accommodating groove 313.

Advantageously, the quantities of the snap-fit parts 322 and the elastic bulges 41 are both two. In order to make the snap-fit parts 322 uniformly forced when external force rotates the first connector 31 or the second connector 32, the snap-fit parts 322 are uniformly arranged.

In order to conveniently arrange the elastic bulges 41 in the accommodating groove 313, the first connector 31 and the second connector 32 can be securely fastened. The vertical distance of the elastic bulges 41 protruding from the butt-joint groove 311 is 1 mm-2 mm. Advantageously, the vertical distance of the elastic bulges 41 protruding from the butt-joint groove 311 is 1.5 mm.

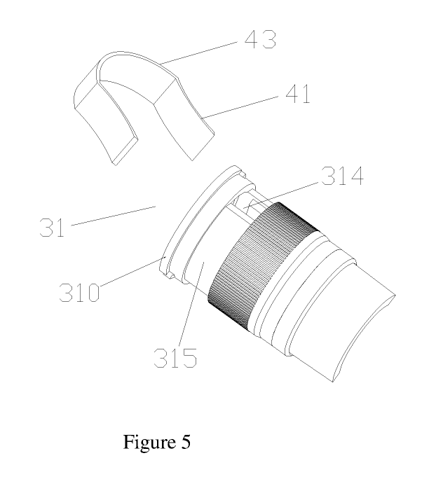

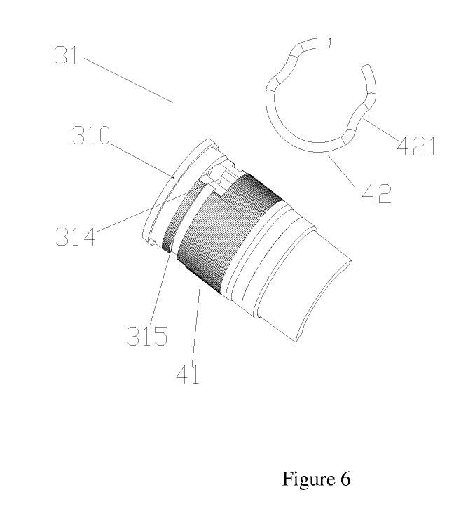

As shown in FIG. 5 and FIG. 6, specifically, the arrangement of the elastic bulges 41 is as follow: an outer side of the first electrode 310 is circumferentially provided with a catching piece, parts of the catching piece protrudes to form the elastic bulges 41, the first electrode 310 is provided with an opening 314 which matches the sizes of the elastic bulges 41, the elastic bulges 41 are exposed inside the butt-joint groove 311 via the opening 314.

In order to securely catch the catching piece on an outer side of the first electrode 310, an outer side of the first electrode 310 is provided with a groove 315 which matches the shape of the catching piece, the catching piece is caught inside the groove 315. The catching piece is caught in the groove 315. It can be understood that the catching piece is elastic.

As the first connector of the first embodiment shown in FIG. 5, the catching piece is a u-shaped elastic piece 43, the elastic bulges 41 are arranged at two ends of the u-shaped elastic piece 43. It can be understood that the elastic bulges 41 can be linear or arc, only if the butt-joint groove 311 can be exposed from the opening 314.

As the first connector of the second embodiment shown in FIG. 6: the catching piece is a catch spring 42 with the opening 314, the elastic bulges 41 are two radial inward protruded convex ribs 421.

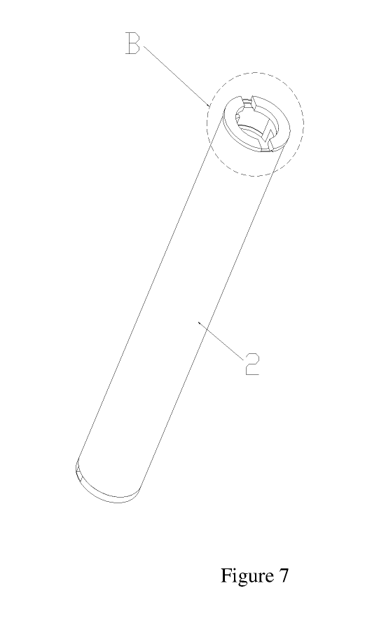

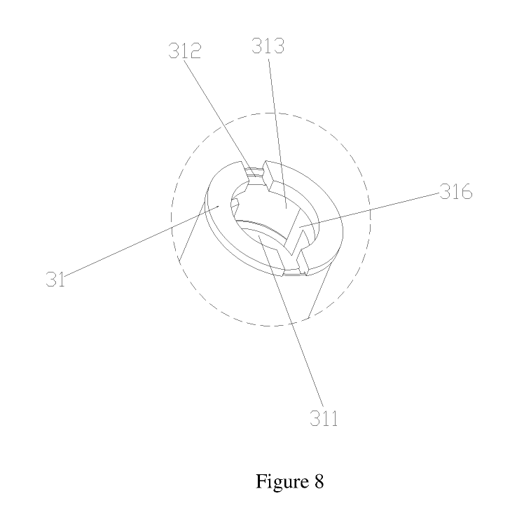

As shown in FIG. 7 and FIG. 8, the snap-fit parts 322 can be a metal piece, the locking part is a magnetic piece 316 which is arranged at an inner wall of the accommodating groove 313 and is used for attracting the snap-fit parts 322. The first connector 31 and the second connector 32 are securely fastened by magnetically attracting the snap-fit parts 322.

The present invention applies the u-shaped elastic piece 43 advantageously.

The above-mentioned embodiments and the figures only show that the first connector 31 is mounted on the atomizing assembly 1 and the second connector 32 is mounted on the battery assembly 2. It can be understood that the first connector 31 can be mounted on the battery assembly 2 and the second connector 32 can be mounted on the atomizing assembly 1.

Moreover, the present invention further provides an electronic cigarette manufacturing method, used for manufacturing the above-mentioned electronic cigarette, the electronic cigarette manufacturing method comprises following steps:

S1. providing a first connector 31 and a second connector 32 that are butt-jointed with each other; a first outer electrode is arranged outside the first connector 31, a second inner electrode is arranged outside the second connector 32, the first connector 31 is provided with a butt-joint groove 311 into which the second connector 32 is inserted; an outer side of the second electrode 320 is provided with outward protruded snap-fit parts 322;

S2. forming a step part which is used for guiding the second connector 32 to insert into the butt-joint groove 311 by extending from one end of the second electrode 320 close to the first connector 31 by reducing diameter;

S3. arranging a guide channel 312 which is connected to an outer end face of the first connector 31 at a side wall of the butt-joint groove 311, and arranging an accommodating groove 313 which is connected to the guide channel 312 at an end of the guide channel 312 away from an outer end face of the first connector 31;

S4. providing a u-shaped elastic piece 43 with two inward protruded elastic bulges 41 on two ends, arranging a groove 315 which matches with the u-shaped elastic piece 43 at an outer side of the first electrode 310, and arranging an opening 314 used for being inserted by the elastic bulges 41 and protruding the elastic bulges 41 from an interior of the butt-joint groove 311;

S5. providing a battery assembly 2 and an atomizing assembly 1, catching the u-shaped elastic piece 43 on an outer side of the first electrode 310, and inserting the elastic bulges 41 into the opening 314, mounting the first connector 31 with the u-shaped elastic piece 43 on the battery assembly 2, mounting the second connector 32 on the atomizing assembly 1, and inserting the second connector 32 into the butt-joint groove 311, rotating and snap-fitting to form the electronic cigarette.

Advantageously, the quantities of the opening 314, the elastic bulges 41 and the snap-fit parts 322 are all two.

When the first connector 31 and the second connector 32 are snap-fitted, the two snap-fit parts 322 are restricted between the two elastic bulges 41.

In conclusion, by inserting the second connector 32 into the first connector 31 and rotating to snap-fit, the first connector 31 and the second connector 32 are connected securely. Meanwhile, by arranging the guide part on an end of the second connector 32 close to the first connector 31, it is convenient to insert the second connector 32 into the butt-joint groove 311. Moreover, as the alignment is precise, the abrasion for the second connector and the first connector can be reduced. And by arranging the locking part to preventing the first connector 31 from rotating with respect to the second connector 32, the first connector 31 and the second connector 32 can be connected securely.

Combining with the accompanying drawings, embodiments of the present invention are described. However, the present invention is not limited by the above embodiments, which means that the above specific embodiments are only schematic, rather than restrictive. It should be understood that, in the inspiration of the present invention, those skilled in the art who appreciate and realize all or part of the process in above embodiments may make many modifications or alternatives, without going beyond the purpose and the scope the claims intend to protect of the present application. All these belong to the protection of the present invention.

What is claimed is:

1. An electronic cigarette, comprising an atomizing assembly (1) and a battery assembly (2), a connection structure is provided at where the atomizing assembly (1) and the battery assembly (2) are butt-jointed, and the connection structure comprises a first connector (31) and a second connector (32) that are butt-jointed with each other,
wherein the first connector (31) is provided with a butt-joint groove (311) into which the second connector (32) is inserted; the second connector (32) is provided with a connecting arm (30) and a guide part (321) which is formed by extending from one end of the connecting arm (30) by way of reducing diameter, the end is close to the first connector (31), the guide part (321) is used for guiding the second connector (32) to insert into the butt-joint groove (311);
wherein the connecting arm (30) comprises outward protruded snap-fit parts (322), an inner wall of the butt-joint groove (311) is provided with a guide channel (312) providing an insertion guide for the snap-fit parts (322), and an accommodating groove (313) which is communicated with the guide channel (312) and is used for being in a rotary snap-fit with the snap-fit parts (322).

2. The electronic cigarette according to claim 1, wherein the first connector (31) is further provided with locking parts used for preventing the first connector (31) from rotating with respect to the second connector (32).

3. The electronic cigarette according to claim 2, wherein the locking part are elastic bulges (41) arranged at a side wall of the accommodating groove (313).

4. The electronic cigarette according to claim 3, wherein a guide face is arranged on the guide part (321), the guide face is arranged at an end which is opposite to the connecting arm (30).

5. The electronic cigarette according to claim 4, wherein the guide part (321) is an inverted beveling angle or an inverted rounding angle which is arranged at an end of the second connector (32) close to the first connector (31), the inverted beveling angle or the inverted rounding angle encircles a circumferential face, the circumferential face forms the guide face.

6. The electronic cigarette according to claim 4, wherein the guide part (321) is a step part which is formed by extending from an end of the second connector (32) by way of gradually reducing a diameter, the end is close to the first connector (31), and a circumferential surface of the step part forms the guide face.

7. The electronic cigarette according to claim 6, wherein a first electrode (310) is arranged outside the first connector (31), a second electrode (320) is arranged outside the second connector (32) and is electrically connected to the first electrode (310), the snap-fit parts (322) are arranged at an outer side of the second electrode (320), the butt-joint groove (311) is formed at an inner side of the first electrode (310).

8. The electronic cigarette according to claim 7, wherein an outer side of the first electrode (310) is circumferentially provided with a catching piece, parts of the catching piece protrudes to form the elastic bulges (41), the first electrode (310) is provided with an opening (314) which matches sizes of the elastic bulges (41), the elastic bulges (41) are exposed inside the butt-joint groove (311) via the opening (314).

9. The electronic cigarette according to claim 8, wherein an outer side of the first electrode (310) is provided with a groove (315) which matches a shape of the catching piece, the catching piece is caught inside the groove (315).

10. The electronic cigarette according to claim 8, wherein the catching piece is a u-shaped elastic piece (43), the elastic bulges (41) are arranged at two ends of the u-shaped elastic piece (43).

11. The electronic cigarette according to claim 8, wherein the catching piece is a catch spring (42) with the opening (314), the elastic bulges (41) are two radial inward protruded convex ribs (421).

12. The electronic cigarette according to claim 2, wherein the snap-fit parts (322) are metal pieces, the locking part is a magnetic piece (316) which is arranged at an inner wall of the accommodating groove (313) and is used for attracting the snap-fit parts (322).

13. The electronic cigarette according to claim 8, wherein the quantities of the snap-fit parts (322) and the elastic bulges (41) are both two, the snap-fit parts (322) are uniformly arranged at the outer side of the second electrode (320) with an equivalent interval.

14. The electronic cigarette according to claim 8, wherein a vertical distance of the elastic bulges (41) protruding from the butt-joint groove (311) is 1 mm-2 mm.

15. The electronic cigarette according to claim 1, wherein the first connector (31) is mounted on the battery assembly (2), the second connector (32) is arranged on the atomizing assembly (1).

16. An electronic cigarette, comprising an atomizing assembly (1) and a battery assembly (2), a connection structure is provided at where the atomizing assembly (1) and the battery assembly (2) are butt-jointed, and the connection structure comprises a first connector (31) and a second connector (32) that are butt-jointed with each other,
wherein the first connector (31) is provided with a butt-joint groove (311) into which the second connector (32) is inserted; the second connector (32) is provided with a connecting arm (30) and a guide part (321) which is formed by extending from one end of the connecting arm (30) by way of reducing diameter, the end is close to the first connector (31), the guide part (321) is used for guiding the second connector (32) to insert into the butt-joint groove (311);
wherein the connecting arm (30) comprises outward protruded snap-fit parts (322), an inner wall of the butt-joint groove (311) is provided with a guide channel (312) providing an insertion guide for the snap-fit parts (322), and an accommodating groove (313) which is communicated with the guide channel (312) and is used for being in a rotary snap-fit with the snap-fit parts (322);
wherein a guide face is arranged on the guide part (321), the guide face is arranged at an end which is opposite to the connecting arm (30); the guide part (321) is a step part which is formed by extending from one end of the second connector (32) by way of gradually reducing a diameter, the end is close to the first connector (31); the connecting arm (30) comprises an outward protruded locking part used for preventing the first connector (31) from rotating with respect to the second connector (32); the locking part is two elastic bulges (41) which are arranged at a side wall of the accommodating groove (313).

17. An electronic cigarette manufacturing method, used for manufacturing the electronic cigarette in claim 16, wherein the electronic cigarette manufacturing method comprises following steps:
S1. providing the first connector (31) and the second connector (32) that are butt-jointed with each other; a first electrode is arranged outside the first connector (31), a second electrode is arranged outside the second connector (32), the first connector (31) is provided with the butt-joint groove (311) into which the second connector (32) is inserted; an outer side of the second electrode (320) is provided with the snap-fit parts (322) which is protruded outward;
S2. forming the step part which is used for guiding the second connector (32) to insert into the butt-joint groove (311) by extending from one end of the second electrode (320) by way of reducing diameter, the end being close to the first connector (31);
S3. arranging the guide channel (312) which is connected to an outer end face of the first connector (31) at a side wall of the butt-joint groove (311), and arrange the accommodating groove (313) which is communicated with the guide channel (312) at an end of the guide channel (312) which is opposite to an outer end face of the first connector (31);
S4. providing a u-shaped elastic piece (43) with two of the elastic bulges (41) which are inward protruded on two ends, arrange a groove (315) which matches with the u-shaped elastic piece (43) at an outer side of the first electrode (310), and arrange an opening (314) used for being inserted by the elastic bulges (41) and protrude the elastic bulges (41) from an interior of the butt-joint groove (311);
S5. providing the battery assembly (2) and the atomizing assembly (1), catching the u-shaped elastic piece (43) on an outer side of the first electrode (310), and inserting the elastic bulges (41) into the opening (314), mount the first connector (31) with the u-shaped elastic piece (43) on the battery assembly (2), mount the second connector (32) on the atomizing assembly (1), and insert the second connector (32) into the butt-joint groove (311), rotate and snap-fit to form the electronic cigarette.
